(19) United States
(12) Patent Application Publication
(10) Pub. No.: US 2013/0155663 A1
(43) Pub. Date: Jun. 20, 2013

(54) Outdoor Light Fixture Apparatuses and Methods For Locating and Identifying Markers of Interest

(71) Applicant: David L. Ballard, Belle, WV (US)

(72) Inventor: David L. Ballard, Belle, WV (US)

(21) Appl. No.: 13/721,301

(22) Filed: Dec. 20, 2012

Related U.S. Application Data
(60) Provisional application No. 61/577,987, filed on Dec. 20, 2011.

(51) Int. Cl. F21L 4/02; F21V 21/00; F21L 4/08

(52) U.S. Cl. CPC F21L 4/02; F21L 4/08; F21V 21/00
USPC 362/183; 362/184; 362/230; 362/231

(57) ABSTRACT

Apparatuses and methods described herein may allow markers of interest to be located and identified according to an industry and item of interest. In one embodiment, an outdoor light fixture apparatus comprises a housing comprising a mounting surface and a top surface, a solar panel affixed to the top surface of the housing, a mounting mechanism affixed to the mounting surface, and a rechargeable battery positioned within the housing. The outdoor light fixture apparatus also comprises a first light emitting diode with a first light color corresponding to the American Public Works Association Uniform Color Code for an industry classification of an item of interest at or near the outdoor light fixture apparatus, a second light emitting diode with a second light color, wherein the second light emitting diode is separated from the first light emitting diode by a distance, and a printed circuit board positioned within the housing, wherein the printed circuit board comprises at least one switch to control the first and second light colors and wherein the distance separating the first and second light emitting diodes is such that the first light emitting diode is visually discernable from the second light emitting diode.

### CROSS-REFERENCE TO RELATED APPLICATIONS

The application claims the benefit of U.S. Provisional Patent Application Ser. No. 61/577,987 filed Dec. 20, 2011, titled “Outdoor Light Fixture for Markers.”

### FIELD

The disclosure relates to outdoor light fixture apparatuses and methods that may locate and identify markers of interest, where the outdoor light fixture apparatuses are mounted on or near the markers of interest.

### BACKGROUND

Items of interest, such as electrical grid infrastructure or underground gas pipelines, may be marked by a marker, such as a post, sign, cone, or other marking device. These markers may be termed markers of interest and may be located at, on, or near the item of interest. The markers may provide information in addition to locating a particular item of interest, such as information regarding the item of interest, including a description of the specific item near the marker, the industry with which the marker is associated, or a warning to passersby or emergency personnel. For example, a marker of interest may by placed above an underground gas pipeline or an underground water line, and the marker of interest may also provide a warning to passersby regarding the location of the gas or water pipeline and to exercise caution when digging. The marker of interest may also allow emergency personnel to locate the gas or water pipeline in the event of a leak or other emergency. However, these markers of interest are generally difficult to locate in the dark, even for a person familiar with the area and the location of the marker of interest. This may result in damage to infrastructure, utilities, or other equipment, as an unaware driver may not be able to see a marker of interest in the dark or when pulling a vehicle over to the shoulder during an emergency. Additionally, a quick response to an emergency may dramatically affect the outcome of the emergency, for example, resulting in saved lives. However, if emergency personnel are unable to locate a marker of interest and the associated item of interest in a timely manner, the emergency response may be delayed. Difficulty in locating the marker of interest and an associated item of interest in the dark may therefore result in a slower response to the emergency. Accordingly, apparatuses and methods to quickly locate and identify a marker of interest are needed.

### SUMMARY

Embodiments disclosed herein include outdoor light fixture apparatuses and methods that may include light emitting diodes (LEDs) that help locate and identify a marker of interest. The outdoor light fixture apparatuses and methods disclosed herein can be provided as part of a new marker of interest or mounted to existing markers of interest. As a non-limiting example, the outdoor light fixture apparatuses described herein may be programmed such that the LEDs convey information based on an LED color.

In one embodiment, an outdoor light fixture apparatus comprises a housing comprising a mounting surface and a top surface, a solar panel affixed to the top surface of the housing, a mounting mechanism affixed to the mounting surface, and a rechargeable battery positioned within the housing. The outdoor light fixture apparatus also comprises a first light emitting diode with a first light color corresponding to the American Public Works Association Uniform Color Code for an industry classification of an item of interest at or near the outdoor light fixture apparatus, a second light emitting diode with a second light color, wherein the second light emitting diode is separated from the first light emitting diode by a distance, and a printed circuit board positioned within the housing, wherein the printed circuit board comprises at least one switch to control the first and second light colors and wherein the distance separating the first and second light emitting diodes is such that the first light emitting diode is visually discernable from the second light emitting diode.

In another embodiment, a method of identifying a marker of interest comprises identifying a first light color for a first light emitting diode corresponding to the American Public Works Association Uniform Color Code, identifying a second light color for a second light emitting diode based on an item of interest located at or near a marker of interest, and providing an outdoor light fixture apparatus including a printed circuit board, wherein the printed circuit board comprises at least one switch to assign the first and second light colors. The method also includes programming the printed circuit board such that the first light color for the first light emitting diode corresponds to the American Public Works Association Uniform Color Code, programming the printed circuit board such that the second light color of the second light emitting diode corresponds to the item of interest, and affixing the outdoor light fixture apparatus to the marker of interest using a mounting mechanism.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

FIG. 1 illustrates a front view of one embodiment of an outdoor light fixture apparatus with a first light emitting diode and a second light emitting diode;

FIG. 2 illustrates a top view of the outdoor light fixture apparatus of FIG. 1;

FIG. 3 is a side view of the outdoor light fixture apparatus of FIG. 1;

FIG. 4 illustrates one embodiment of the outdoor light fixture apparatus of FIG. 1 mounted on a marker of interest;

FIG. 5 is a close-up view of the outdoor light fixture apparatus of FIG. 1 mounted on the marker of interest of FIG. 4;

FIG. 6 is an illustration of the outdoor light fixture apparatus of FIG. 1 mounted on the marker of interest of FIG. 4 positioned near a building;

FIGS. 7A-7B are tables illustrating one embodiment of color schemes for the first and second light emitting diodes of the outdoor light fixture apparatus of FIG. 1;

FIG. 8 illustrates sample combinations of color schemes.

### DETAILED DESCRIPTION

Embodiments disclosed herein generally relate to outdoor light fixture apparatuses and methods for locating and identifying markers of interest. An outdoor light fixture apparatus may be mounted to a marker of interest and may contain a first and second light emitting diode (LED). The first and second light emitting diodes may be color coded according to a color scheme to allow a user to not only locate the marker of interest in the dark due to the light emitted from the LEDs, but also to identify the marker of interest based on the colors of the LEDs. As will be described in greater detail below, the outdoor light fixture apparatus may be mounted using a mounting mechanism and may be designed to retroactively fit different styles of markers of interest.

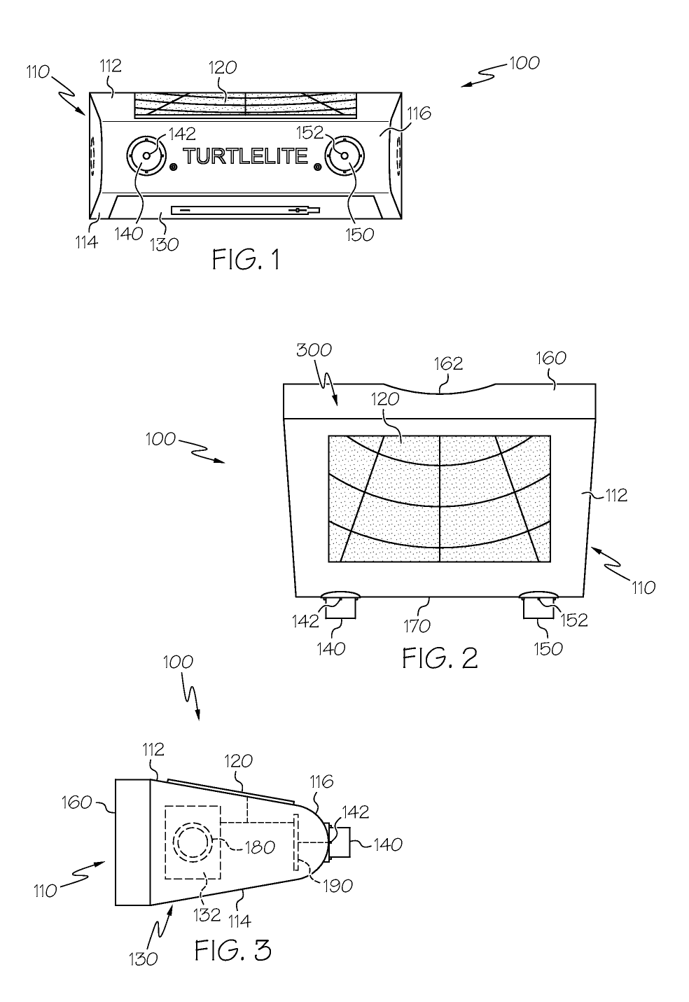

In FIG. 1, one embodiment of an outdoor light fixture apparatus 100 is illustrated with a housing 110. The housing 110 can be a box-like shape, as shown in FIG. 1, with a top surface, a bottom surface, and four or more supporting surfaces. In the orientation shown in FIG. 1, the outdoor light fixture apparatus 100 has an upper surface 112, a lower surface 114, and a front surface 116. A solar panel 120 is attached to the upper surface 112 of the housing 110 of the outdoor light fixture apparatus 100. A rechargeable battery compartment access door 130 is located on the lower surface 114 of the housing 110 of the outdoor light fixture apparatus 100. A left side LED housing 140 and a first LED 142 are located on a left hand side of the front surface 116 of the housing 110 of the outdoor light fixture apparatus 100. A right side LED housing 150 and a second LED 152 are located on a right side of the front surface 116 of the housing 110 of the outdoor light fixture apparatus 100. The first and second LEDs 142, 152 are separated by a distance, such that light emitted from the first LED 142 is visually discernable from light emitted from the second LED 152. The light emitted from the first and second LEDs 142, 152 may be visually discernable by a human with average eyesight from a distance of about 800 feet. In other embodiments, the outdoor light fixture apparatus 100 may be shaped differently, such as a triangle shape or semi-circle shape, and the LEDs may be oriented vertically.

The solar panel 120 may be a four-cell solar panel, or a five-cell solar panel, or a three-cell solar panel, or any other solar panel that fits within the dimensions of the upper surface 112 of the housing 110 of the outdoor light fixture apparatus 100. The solar panel 120 may also be a two-volt solar panel, a four-volt solar panel, or any other voltage solar panel that fits within the dimensions of the upper surface 112 of the housing 110. The rechargeable battery compartment access door 130 may be of a size less than or equal to the dimensions of the lower surface 114 of the housing 110 of the outdoor light fixture apparatus 100 and may be separable from the housing 110 of the outdoor light fixture apparatus 100, or may remain attached to the housing 110 of the outdoor light fixture apparatus 100 with a hinge connection and swing open and closed in order to allow access to the rechargeable battery compartment 132 (shown in FIG. 3). In some embodiments, the rechargeable battery compartment access door 130 may be connected to the housing 110 of the outdoor light fixture apparatus 100 by a hinge connection, or a lanyard connection, or another tethering device to avoid fully detaching the rechargeable battery compartment access door 130. The first and second side LED housings 140, 150 may be of a neutral color or may be tinted. If the LED housings 140, 150 are tinted, it may not be necessary for the first and second LEDs 142, 152 to be of a certain color, as the color of light emitted may reflect the color of the tint on the LED housings 140, 150. In other embodiments, the first and second side LED housings 140, 150 may be a neutral or clear color, allowing the color of light emitted from the first and second LEDs 142, 152 to be visible through the first and second side LED housings 140, 150. This may allow the color of the light emitted from the first and second LEDs 142, 152 to be viewable from a distance outside of the housing 110 of the outdoor light fixture apparatus 100. The first and second LEDs 142, 152 may be a same color or may be different colors.

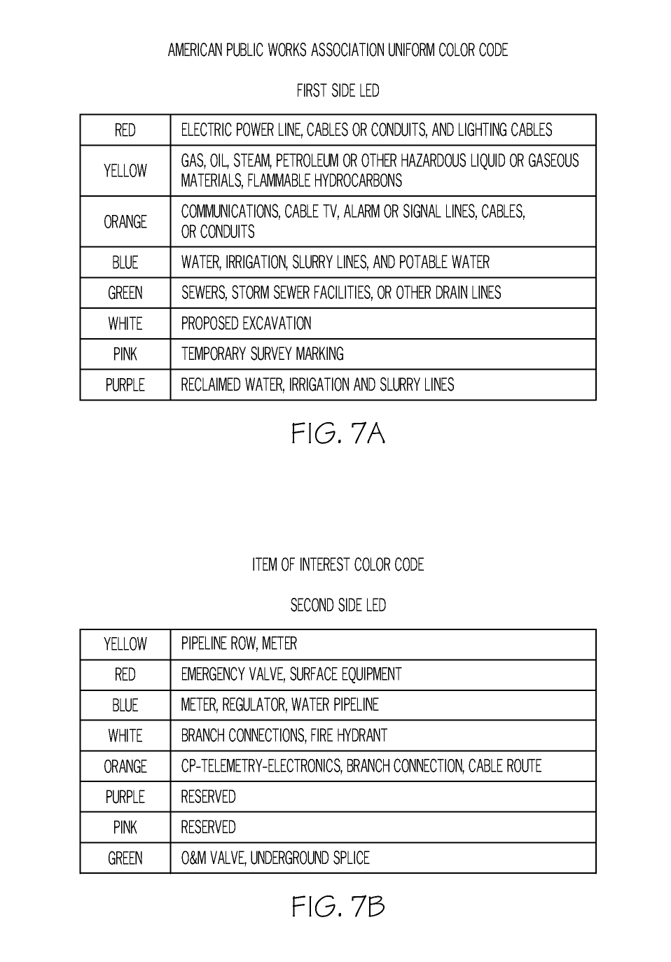

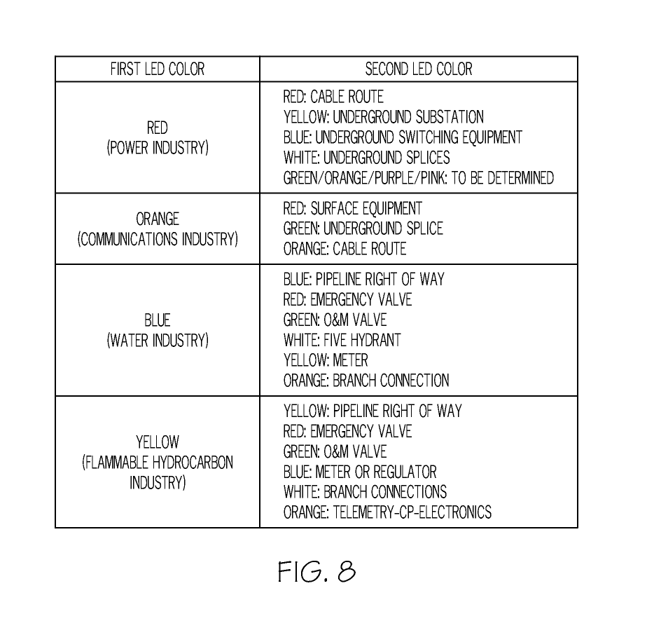

In some embodiments, the color of light emitted from the first and second LEDs 142, 152 may be programmable using a printed circuit board (PCB) 190 to indicate certain information to a user, as discussed below. In other embodiments, the color of the first and second LEDs 142, 152 may be fixed. The color of light emitted from the first LED 142 may be associated with the American Public Works Association Uniform Color Code (APWA-UCC) for utility markers and may be used to identify an industry associated with a marker of interest 200, as discussed below. The APWA-UCC uses the color scheme provided in FIG. 7A, where the colors in the left column are associated with the industry in the right column. The color of light emitted by the second LED 152 may be used to identify items of interest associated with the marker of interest 200, such as pipelines, valve, meters, regulators, branch connections, electronics, fire hydrants, cable routes, surface equipment, underground splices, or other items of interest. The color of the second LED 152 may be associated with the color scheme provided in FIG. 7B, where the color in the left column is associated with the item of interest in the right column. Combined, the first and second LEDs 142, 152 may allow a user to locate the marker of interest 200, determine the industry the marker of interest 200 is associated with based on the color of the first LED 142, and the item of interest located at or near the marker of interest 200 based on the color of the second LED 152.

By viewing the color of light emitted by both the first and second LEDs 142, 152, a user may be able to determine where a utility marker, gas pipeline, water pipeline, electricity line, or other location or marker of interest 200 is located, and may also further be able to identify the particular item of interest located at or near the marker of interest 200 by combining the information provided from the color of the first LED 142 with the information provided from the color of the second LED 152. This may make it less difficult for a utility worker to locate a pipeline or wire or other item of interest in the dark and may also make it easier for the marker to be more visible in low light conditions, which may reduce the amount of damage sustained by the items of interest by unsuspecting motorists and other passersby. The light from the LEDs 142, 152 may be visible from a distance, which may also make it easier to locate the marker of interest 200, and therefore the item of interest, in the dark or in low lighting conditions. Additionally, residual light from the LEDs 142, 152 may illuminate the marker of interest 200, allowing a user to read the marker of interest from a distance. The LEDs 142, 152 may be programmed to be in a fixed illuminated state, or may be programmed to operate in a flashing mode.

In FIG. 2, a top view of the housing 110 of the outdoor light fixture apparatus 100 is shown. The solar panel 120 may be as large as the dimensions of the upper surface 112 of the housing 110 of the outdoor light fixture apparatus 100. A mounting surface 160 is shown that may be the only surface of the housing 110 of the outdoor light fixture apparatus 100 that contacts the marker of interest 200. A mounting cut-out area 162 is located near the center of the mounting surface 160 of the housing 110 of the outdoor light fixture apparatus 100. The mounting cut-out area 162 may provide flexibility in mounting the outdoor light fixture apparatus 100 on certain markers with protrusions, and may also increase the number of markers with which the outdoor light fixture apparatus 100 is compatible with. The outdoor light fixture apparatus 100 may be mounted to a marker using a mounting mechanism such as a nut and bolt assembly, a screw, or a mounting tape 300 or other mounting mechanism. The mounting tape 300 may be a two-sided tape and may have certain material specifications. The mounting tape 300 may be applied to the mounting surface 160 and the other side of the two-sided mounting tape may be applied to the marker.

FIG. 3 illustrates a side view of the housing 110 of the outdoor light fixture apparatus 100. A rechargeable battery 180 is positioned within the housing 110 in the rechargeable battery compartment 132 and is accessible through the rechargeable battery compartment access door 130. The rechargeable battery 180 may be a rechargeable battery such as a 900 milliamp-hour (mah) or larger nickel-cadmium (NiCad) rechargeable battery or any other rechargeable battery that fits within the rechargeable battery compartment 132. Additionally, the rechargeable battery 180 may be replaceable. The rechargeable battery 180 supplies power to the first and second LEDs 142, 152, allowing the first and second LEDs 142, 152 to illuminate. The rechargeable battery 180 may be connected to and recharged by the solar panel 120. The printed circuit board (PCB) 190 may be included within the housing 110 of the outdoor light fixture apparatus 100. The PCB 190 may be connected to the solar panel 120, the rechargeable battery 180, the first and second LEDs 142, 152, and may also be attached to a photo cell. The photo cell may function to detect sunlight or exposure to a source of light. When a source of light is detected by the photo cell, the PCB 190 may use hardware logic to activate the solar panel 120. When the source of light is no longer detected by the photo cell, the PCB 190 may use hardware logic to deactivate the solar panel 120. The solar panel 120 may also be connected to the rechargeable battery 180. When the solar panel 120 is activated, the solar panel 120 may charge the rechargeable battery 180. The PCB 190 may use hardware logic to control the amount and flow at which the rechargeable battery 180 is charged by the solar panel 120. When the rechargeable battery 180 is fully charged, the rechargeable battery may be able to supply up to 14 hours of power for the first and second LEDs 142, 152 to remain illuminated. Additionally, a two-volt, four-cell solar panel 120 may be able to charge a 900 mah NiCad battery to operate for about 8 hours with about 4 hours of charge time. The PCB 190 may also activate or deactivate the first and second LEDs 142, 152 depending on input from the photo cell. For example, when the photo cell indicates a light source is available, the PCB 190 may deactivate the first and second LEDs 142, 152, and when the photo cell indicates no light source is available, the PCB 190 may activate the first and second LEDs 142, 152. In other embodiments, the PCB 190 may activate or deactivate the first and second LEDs 142, 152 or the solar panel 120 based on a timer, or based on other preset logic contained on the PCB 190. The PCB 190 may also cause the first and second LEDs 142, 150 to flash rather than remain in an illuminated state, which may conserve the life of the rechargeable battery 180.

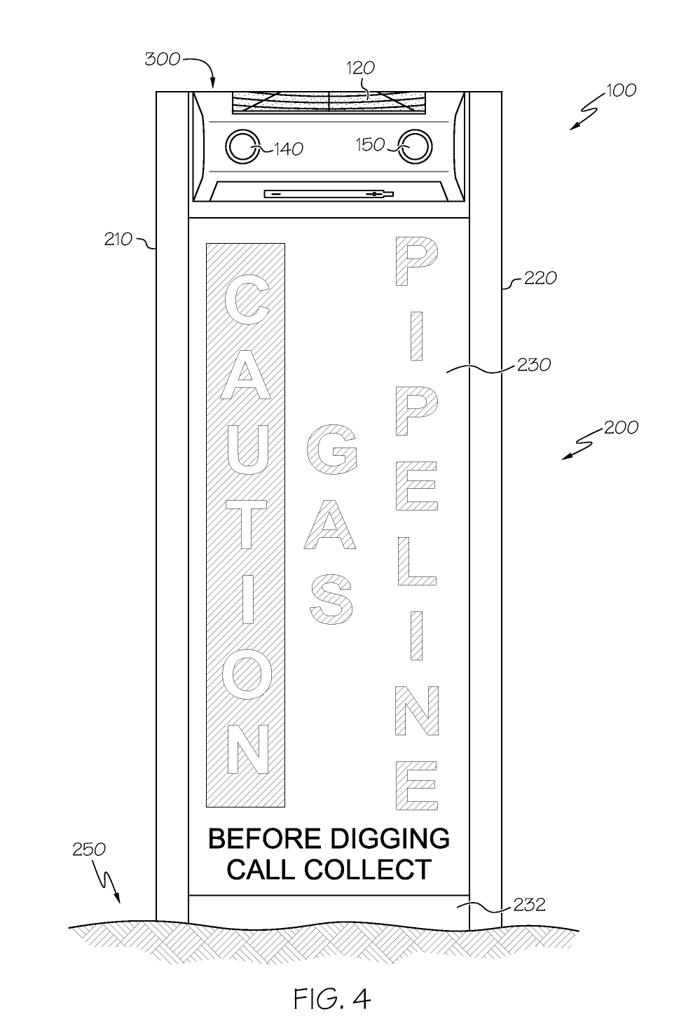

FIG. 4 illustrates the outdoor light fixture apparatus 100 mounted to the marker of interest 200. The marker of interest 200 may have a label 230 posted on a central face 232, as shown in FIG. 4, indicating that the marker of interest 200 is associated with a specific industry or other relevant information. The marker of interest 200 shown in FIG. 4 indicates that a “Gas Pipeline” is located at or near the marker of interest 200. The marker of interest 200 may have edges 210, 220 that are thicker than the central area 232 of the marker of interest 200 or that may be of a different shape or surface material. The marker of interest 200 may be placed directly into the ground 250. In other embodiments, the marker of interest 200 may be placed directly on a pipeline, mounted to a wall, or placed adjacent to an associated item of interest. The outdoor light fixture apparatus 100 is mounted such that the solar panel 120 is facing upwards. This ensures that the first LED 142 and the second LED 152 are properly oriented, and also that the solar panel 120 may be exposed to as much light as possible. In the embodiment shown in FIG. 4, the outdoor light fixture apparatus 100 is mounted using mounting tape 300. The mounting tape 300 may be a two-sided, conformable tape, where a first side of the mounting tape 300 is attached to the mounting surface 160 of the outdoor light fixture apparatus 100 and a second side of the mounting tape 300 is attached to the marker of interest 200. The mounting tape 300 may be a tape specially formulated for the outdoor light fixture apparatus 100 to be mounted to the marker of interest 200, and may have special material properties, such as reaching about 90% of bond strength within about 10 minutes of application. One example of the mounting tape 300 is commercially available as 3M #4941 tape.

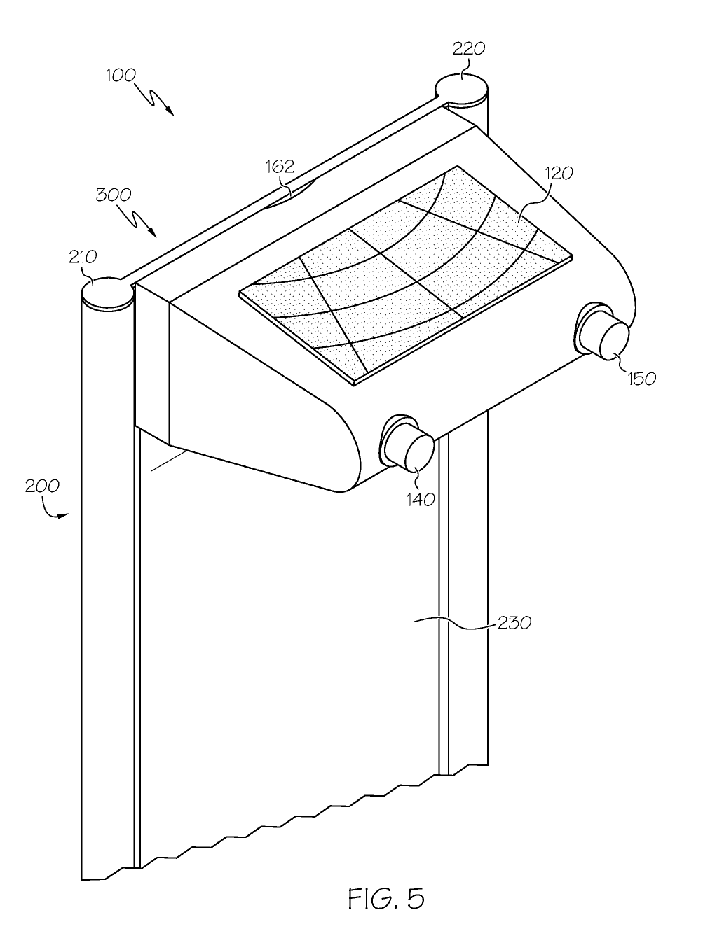

FIG. 5 is a close-up view of the outdoor light fixture apparatus 100 mounted to the marker of interest 200. The mounting cut-out area 162 is not needed for this particular marker of interest 200, but may be required to mount the outdoor light fixture apparatus 100 to certain markers of interest 200. Orientation of the outdoor light fixture apparatus 100 is fixed because the outdoor light fixture apparatus 100 can be mounted such that it is in a horizontal position, as shown in FIG. 5. Because most markers of interest 200 are thin, it may be difficult to mount the outdoor light fixture apparatus 100 in a vertical orientation. The outdoor light fixture apparatus 100 mounting orientation may therefore be fixed, as the solar panel 120 may be positioned such that it is on the upper surface 112 of the outdoor light fixture apparatus 100. Therefore, the orientation of the first and second LEDs 142, 152 may be fixed regardless of the type of marker of interest 200 that the outdoor light fixture apparatus 100 is mounted to. Additionally, the outdoor light fixture apparatus 100 may be of a width limited to the distance between the edges 210, 220 of the marker of interest 200, such that the outdoor light fixture apparatus 100 can be mounted between the edges 210, 220 of the marker of interest 200.

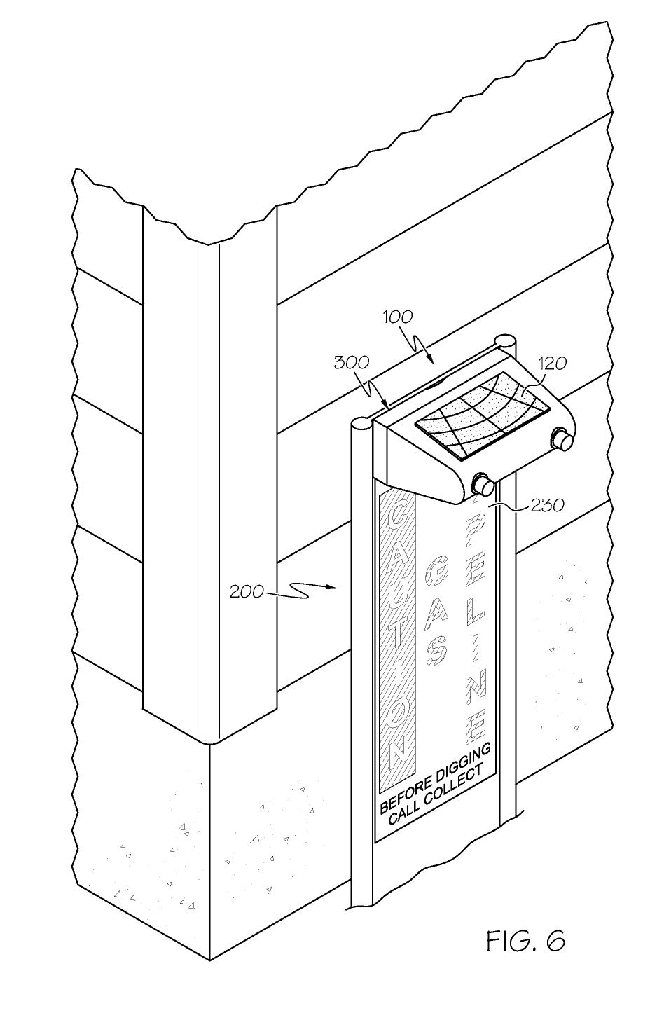

FIG. 6 is an illustration of the outdoor light fixture apparatus 100 mounted to the marker of interest 200 along a side of a building. FIG. 6 illustrates how the marker of interest 200 can be located at or near the item of interest that is associated with the marker of interest 200. For example, the marker of interest 200 in FIG. 6 has a label stating “Caution: Gas Pipeline.” This informs passersby that a gas pipeline may be buried or otherwise located at or near the marker of interest 200. In the dark, however, the marker of interest 200 may not be visible as it may not be illuminated. With the outdoor light fixture apparatus 100 mounted on the marker of interest 200, however, a user may be able to locate the marker of interest 200 from a distance because of the light emitted from the first and second LEDs 142, 152 contained in the outdoor light fixture apparatus 100. Additionally, a user may see that the first LED 142 is of a first color, and determine that the marker of interest 200 is identifying a gas utility. The user may also see that the second LED 152 of the outdoor light fixture apparatus 100 is illuminated in a second color, such as blue, indicating that the item of interest associated with the marker of interest 200 is a pipeline. This may allow a user to determine, from a distance, the position of the marker of interest 200, what industry the marker of interest 200 is associated with using the color of the first LED 142, and what item of interest is located near or at the marker of interest 200 using the color of the second LED 152. Additionally, the light emitted from the first and second LEDs 142, 152 may allow the user to read the label 230 on the marker of interest 200 when there would otherwise be insufficient light. This may allow an unsuspecting driver to avoid hitting a utility box or telephone pole or other piece of infrastructure, or may allow emergency personnel, such as firefighters or gas company employees, to quickly respond to an emergency and turn off a gas pipeline or water pipeline by quickly locating and identifying a marker of interest 200.

Referring now to FIG. 8, a sample chart is provided illustrating sample combinations of colors for the first and second side LEDs 142, 152. For example, a red color light emitted from the first LED 142 indicates the power industry, and a red color light from the second LED 152 indicates a cable route. A user may therefore be able to determine a power cable route is located near the outdoor light fixture apparatus 100. Another example, from FIG. 8, is a blue color first LED 142 and a blue color second LED 152, indicating a water pipeline right of way. The sample chart of color information and coordination provided in FIG. 8, or any similar chart or color scheme, can be provided with the apparatus or separately to a user in a form such as a mobile device application or other electronic form or as a print card or other printed media, such as a sticker or booklet.

The above-described outdoor light fixture apparatuses 100 and methods may allow a user to locate a marker of interest 200 in low lighting conditions, and may also allow a user to determine an industry associated with the marker of interest 200, as well as a type of item associated with the marker of interest 200, based on a color of light emitted from first and second LEDs 142, 152. Additionally, the light emitted from the first and second LEDs 142, 152 may help illuminate the marker of interest 200 in the dark, allowing a user to read a label on the marker of interest 200.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. An outdoor light fixture apparatus comprising:
a housing comprising a mounting surface and a top surface;
a solar panel affixed to the top surface of the housing;
a mounting mechanism affixed to the mounting surface;
a rechargeable battery positioned within the housing;
a first light emitting diode with a first light color corresponding to the American Public Works Association Uniform Color Code for an industry classification of an item of interest at or near the outdoor light fixture apparatus;
a second light emitting diode with a second light color, wherein the second light emitting diode is separated from the first light emitting diode by a distance; and
a printed circuit board positioned within the housing, wherein the printed circuit board comprises at least one switch to control the first and second light colors;
wherein the distance separating the first and second light emitting diodes is such that the first light emitting diode is visually discernable from the second light emitting diode.

2. The outdoor light fixture apparatus of claim 1, wherein the mounting mechanism is a mounting tape.

3. The outdoor light fixture apparatus of claim 1, wherein the first and second light colors are identical.

4. The outdoor light fixture apparatus of claim 1, wherein the first and second light emitting diodes are not identical.

5. The outdoor light fixture apparatus of claim 1, wherein the rechargeable battery is a 900 milliamp-hour rechargeable nickel-cadmium battery.

6. The outdoor light fixture apparatus of claim 1, further comprising a photo cell connected to the printed circuit board.

7. The outdoor light fixture apparatus of claim 6, wherein the printed circuit board contains hardware logic executable to activate and deactivate the solar panel based on an input from the photo cell.

8. The outdoor light fixture apparatus of claim 1, wherein the distance separating the first and second light emitting diodes is greater than or equal to 1 inch.

9. The outdoor light fixture apparatus of claim 1, wherein the first and second light colors are adjustable by manually configuring the at least one switch on the printed circuit board.

10. The outdoor light fixture apparatus of claim 1, wherein the industry classification of the item of interest is one of the following: water industry, electrical industry, construction industry, telecommunications industry, sewerage industry, oil industry, emergency services industry or gas industry.

11. The outdoor light fixture apparatus of claim 1, wherein the item of interest is one of the following: pipeline, valve, meter, regulator, branch connection, electronics, fire hydrant, cable route, surface equipment, or underground splice.

12. A method of identifying a marker of interest comprising:
identifying a first light color for a first light emitting diode corresponding to the American Public Works Association Uniform Color Code;
identifying a second light color for a second light emitting diode based on an item of interest located at or near a marker of interest;
providing an outdoor light fixture apparatus including a printed circuit board, wherein the printed circuit board comprises at least one switch to assign the first and second light colors;
programming the printed circuit board such that the first light color for the first light emitting diode corresponds to the American Public Works Association Uniform Color Code;
programming the printed circuit board such that the second light color of the second light emitting diode corresponds to the item of interest; and
affixing the outdoor light fixture apparatus to the marker of interest using a mounting mechanism.

13. The method of claim 12, wherein the mounting mechanism is a mounting tape.

14. The method of claim 12, further comprising activating and deactivating the first and second light emitting diodes with the printed circuit board based on input from a photo cell.

15. The method of claim 12, further comprising activating and deactivating a solar panel with the printed circuit board based on input from a photo cell.

16. The method of claim 15, wherein a rechargeable battery is connected to the solar panel.

17. The method of claim 16, further comprising powering the first and second light emitting diodes with the rechargeable battery.

18. The method of claim 12, wherein the first and second light colors are identical.

19. The method of claim 12, wherein the first and second light colors are not identical.

20. The method of claim 12, wherein the printed circuit board has executable instructions.
